(19) United States
(12) Patent Application Publication
(10) Pub. No.: US 2026/0123786 A1
(43) Pub. Date: May 7, 2026

(54) BEVERAGE DISPENSING SYSTEM

(71) Applicant: DELTA FAUCET COMPANY, Indianapolis, IN (US)

(72) Inventors: Joseph Wayne Baumgarte, Carmel, IN (US); Madeline Clare Ryals, Indianapolis, IN (US); Brian Wayne Johnson, Muncie, IN (US); Gerald Robert Hayes, Lebanon, IN (US)

(21) Appl. No.: 19/117,297

(22) PCT Filed: Sep. 29, 2023
(86) PCT No.: PCT/US2023/034119

§ 371 Date: Apr. 2, 2025

Related U.S. Application Data
(60) Provisional application No. 63/412,362, filed on Sep. 30, 2022.

(51) Int. Cl. A47J 31/52; A47J 31/46; A47J 31/60

(52) U.S. Cl. CPC A47J 31/521; A47J 31/461; A47J 31/60

(57) ABSTRACT

A beverage dispensing system illustratively includes a beverage dispenser having a controller for operating a valve assembly. The controller is illustratively in wireless communication with a remote user interface. In an illustrative embodiment, a hot beverage device may supply hot beverages to a valve assembly, and a cold beverage device may provide cold beverages to the valve assembly.

### CROSS-REFERENCE TO RELATED APPLICATION

The present application claims priority to U.S. Provisional Patent Application Ser. No. 63/412,362, filed Sep. 30, 2022, the disclosure of which is expressly incorporated herein by reference.

### BACKGROUND AND SUMMARY

The present disclosure relates generally to fluid dispensing systems. Illustrative fluid dispensing systems that may be mounted to a sink deck, and be in wireless communication with a remote user interface.

It is known to provide beverage dispensing systems on a countertop for dispensing both hot and cold beverages in response to a user input at a control panel. It is desired to provide a beverage dispensing system that may be mounted adjacent to a sink, and configured to provide wireless communication with a remote user interface. It is also desired to provide a beverage dispensing system that may be voice controlled, is configured for remote control (including for operation, brewing and inventory), collects and analyzes data (including beverages dispensed by kind, amount, date, time, etc.), identifies a user and user preferences/historical data, and/or facilitates operational configuration (e.g., beverage strength, carbonation, etc.). It is also desired to provide a remote user interface, illustratively an application on a smart device, allowing for remote operation, brewing, configuration, inventory, etc.

Beverage faucets generally supply either cold water or instant hot water and are often filtered. Faucets that supply both hot water and cold water are typically configured with two handles, one for hot water and one for cold water, and often are not very aesthetically appealing, having a plain industrial or utilitarian appearance. It is desired to have a beverage faucet that could supply instant hot water, cold water, or mixed water using a single handle, allowing for a more streamlined and pleasing appearance. It is also desired to have the handle self-return to the closed position for safety and convenience purposes.

According to an illustrative embodiment of the present disclosure, a beverage dispensing system includes a beverage dispenser including a spout having an outlet, a valve assembly in fluid communication with the spout, at least one beverage container in fluid communication with the valve assembly, and a controller in communication with the valve assembly. The controller includes a processer, and a memory including machine readable instructions for execution by the processor. A wireless transceiver is in communication with the controller. A remote user interface is in communication with the wireless transceiver.

According to another illustrative embodiment of the present disclosure, a beverage dispensing system includes a beverage dispenser having a spout with an outlet, the spout supported above a sink deck, and a valve assembly in fluid communication with the spout. A refrigerator is positioned below the sink deck, and a plurality of beverage containers are removably supported within the refrigerator. Each of the beverage containers are in fluid communication with the valve assembly. A controller is in communication with the valve assembly. The valve assembly provides selective communication between at least one beverage container and the outlet of the beverage dispenser.

According to another illustrative embodiment of the present disclosure, a beverage faucet includes an outlet, a valve cartridge that allows for water mixing and temperature control through the operation of a single handle operably and fluidly coupled to an instant hot water device. More particularly, the valve cartridge permits delivery of water from a cold water supply to the instant hot water device, delivery of water from the instant hot water device to the outlet of the beverage faucet, delivery of water from the cold water supply to the outlet of the beverage faucet, and delivery of a mixture of water from the instant hot water device and the cold water supply to the outlet of the beverage faucet. The valve cartridge may also provide a vent passageway for the instant hot water device through the beverage faucet.

According a further illustrative embodiment of the present disclosure, a beverage faucet includes a spout having an outlet, a hot water device, and a mixing valve having a moveable valve member. The moveable valve member includes a cold water inlet port in fluid communication with a cold water source, a hot water inlet port in fluid communication with an outlet of the hot water device, a cold water outlet port in fluid communication with an inlet of the hot water device, and a combined water outlet port in fluid communication with the outlet of the spout. Movement of the moveable valve member includes a plurality of operating positions including a closed position, a full cold position, a mix position, and a full hot position.

According to another illustrative embodiment of the present disclosure, a beverage dispensing system includes a beverage dispenser including a spout having an outlet, the spout supported above a sink deck. A user interface is supported by the spout. A water heater is in fluid communication with the spout. A pod storage compartment is supported by the spout and is in fluid communication with the outlet. A cleaning device is in fluid communication with the pod storage compartment, the cleaning device including an air compressor.

Additional features and advantages of the present invention will become apparent to those skilled in the art upon consideration of the following detailed description of the illustrative embodiment exemplifying the best mode of carrying out the invention as presently perceived.

### BRIEF DESCRIPTION OF THE DRAWINGS

A detailed description of the drawings particularly refers to the accompanying figures, in which:

FIG. 1 is a diagrammatic view of an illustrative beverage dispensing system;

FIG. 2 is a diagrammatic view illustrating communication between various components of the beverage dispensing system of FIG. 1;

FIG. 3 is a front plan view, in partial schematic, of the beverage dispensing system of FIG. 1;

FIG. 4 is a side elevational view, in partial schematic, of beverage storage containers of the beverage dispensing system of FIG. 2;

FIG. 5 is a perspective view of an illustrative beverage dispenser;

FIG. 6A is a side elevational view of a further illustrative beverage dispenser;

FIG. 6B is a detailed perspective view of the illustrative beverage dispenser of FIG. 6A;

FIG. 7 is a perspective view of a further illustrative beverage dispenser;

FIG. 8 is a diagrammatic view of an illustrative beverage dispensing system including the beverage dispenser of FIG. 7;

FIG. 9 is a diagrammatic view of another illustrative beverage dispensing system;

FIG. 10 is a diagrammatic view of another illustrative beverage dispensing system;

FIG. 11 is a perspective view of an illustrative mixing valve assembly of the beverage dispenser of FIG. 9;

FIG. 12 is an exploded perspective view of the mixing valve assembly of FIG. 11;

FIG. 13 is top plan view of the valve plates received within the housing of the mixing valve assembly of FIG. 11, with portions of the upper plate shown in phantom, showing the mixing valve assembly is in a closed position;

FIG. 14 is a top plan view similar to FIG. 13, showing the mixing valve assembly in a cold opening position;

FIG. 15 is a top plan view similar to FIG. 14, showing the mixing valve assembly in a full cold position;

FIG. 16 is a top plan view similar to FIG. 15, showing the mixing valve assembly in a cool mix opening position;

FIG. 17 is a top plan view similar to FIG. 16, showing the mixing valve assembly in a warm mix opening position;

FIG. 18 is a top plan view similar to FIG. 17, showing the mixing valve assembly in a hotter mix position;

FIG. 19 is a top plan view similar to FIG. 18, showing the mixing valve assembly in a full hot position;

FIG. 20 is a top plan view of a valve manifold of the mixing valve assembly of FIG. 7;

FIG. 21 is a first cross-sectional view of the illustrative beverage dispenser of FIG. 7;

FIG. 22 is a second cross-sectional view of the illustrative beverage dispenser of FIG. 7; and

FIG. 23 is a third cross-sectional view of the illustrative beverage dispenser of FIG. 7.

### DETAILED DESCRIPTION OF THE DRAWINGS

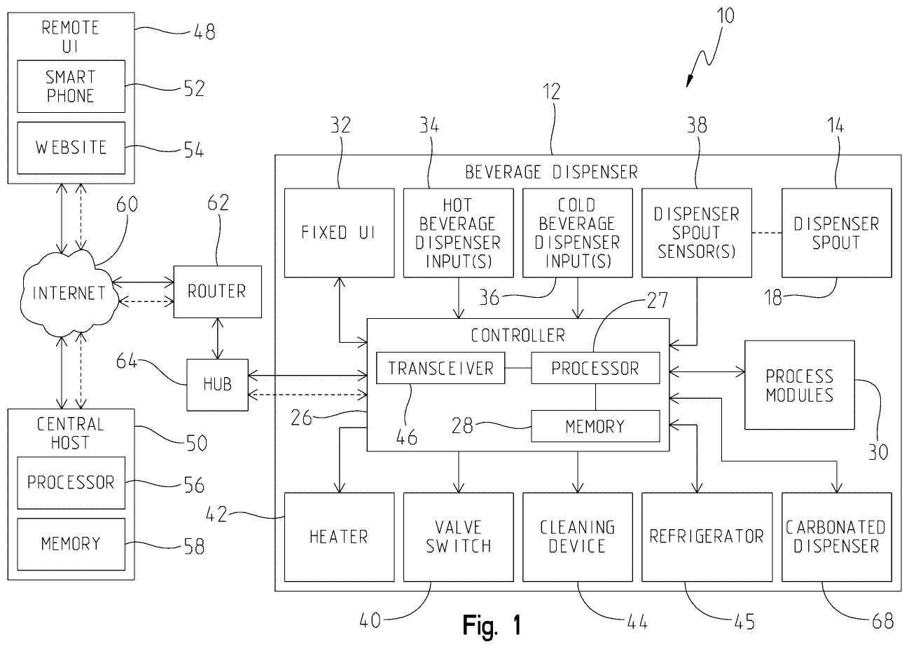

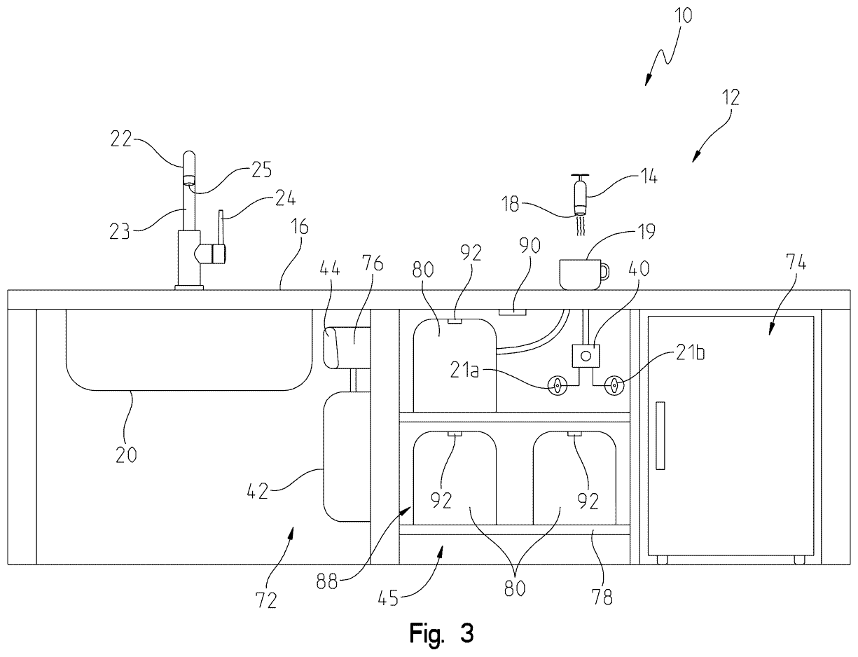

With initial reference to FIGS. 1-3, an illustrative beverage dispensing system 10 of the present disclosure includes a beverage dispenser 12 including a delivery or dispenser spout 14 that may be mounted to a sink deck or countertop 16. The dispenser spout 14 may including an outlet 18 extending above the sink deck 16. A beverage vessel 19, such as a cup or glass, may be supplied (e.g., removably positioned) below the outlet 18. Illustratively, the beverage dispensing system 10 may be fluidly coupled to a conventional water supply 21 (e.g., hot water stop 21a and cold water stop 21b) below the sink deck 16, and the dispensing spout 14 may be supported adjacent (e.g., above) a sink basin 20 (FIG. 3). A conventional faucet 22 may be supported in spaced relation to the dispenser spout 14 to discharge water into the sink basin 20. In another illustrative embodiment, the dispenser spout 14 may be integrated into the faucet 22. The faucet 22 may include a delivery or dispenser spout 23 and a manual valve 24 to control water flow through the spout 23 to an outlet 25.

The illustrative beverage dispenser 12 further includes a controller 26 having a processor 27 in communication with a memory 28. The memory 28 may include machine readable instructions configured to be executed by the processor 27. As further detailed herein, a plurality of process modules 30 may be in communication with the controller 26. These process modules 30 may be part of the machine readable instructions stored in the memory 28 of the controller 26, or separate therefrom for execution by the processor 27.

A fixed user interface (UI) 32 may be supported by the beverage dispenser 12 (e.g., on the spout 14, 23) and is in communication with the controller 26. The user interface 32 may include any combination of conventional push buttons, switches, lights and/or display panels. Various additional input devices and output devices may be in communication with the controller 26. These may include hot beverage dispenser input devices 34 and cold beverage dispenser input devices 36. The input devices 34 and 36 may comprise a variety of sensors, such as temperature sensors, flow sensors, fill level sensors and/or beverage identification sensors. Dispenser spout sensors 38 may by operably coupled to the dispenser spout 14 and in communication with the controller 26.

Illustrative dispenser spout sensors 38 may include any conventional sensor that may be supported on or proximate to the spout 14 to detect an object, for example, a user and/or beverage vessel 19 (e.g., cup or glass) relative to the outlet 18 of the spout 14. More particularly, the sensors 38 may determine if an object is in proximity to (or in contact with) the spout 14. Illustrative sensors 38 may include infrared (IR) sensors, capacitive sensors and/or wireless sensors. Wireless sensors may include, for example, radio frequency (RF) sensors, such as ultra-wideband (UWB) sensors or near field communication (NFC) sensors. The sensors 38 may also include a conventional camera for capturing images.

A valve assembly or switch 40 may be in communication with the controller 24 for controlling fluid flow to the dispensing spout 14. More particularly, the controller 26 may operate the valve assembly 40 to control the flow of water from the water supply 21 (e.g., the hot water stop 21a and the cold water stop 21b) to the outlet 18 of the dispensing spout 14. The valve assembly 40 is illustratively an electrically operable valve, such as a solenoid valve.

A hot beverage device (e.g., a heater 42), a cleaning device 44 and a cold beverage device (e.g., a refrigerator 45) may also be in electrical communication with the controller 26, and in fluid communication with the dispenser spout 14 via the valve assembly 40. The heater 42 may be an instant hot water heater, such as a pressurized heater for quickly heating water supplied to the dispenser spout 14 in response to signals received from the controller 24. The cleaning device 44 may include a controlled fluid (e.g., water or compressed air) to clean portions of the dispenser 12 at predetermined times (e.g., following a certain number of dispensing cycles). As further detailed herein, the refrigerator 45 may store cold beverage components to be supplied to the dispenser spout 14, and its temperature may be controlled by the controller 26.

The controller 26 also illustratively includes a wireless transceiver 46 configured to provide wireless communication with a remote user interface (UI) 48 and/or a central host 50. The remote user interface 48 may comprise, for example, a smart phone 52 or a website 54 (e.g., accessed via a computer). The central host 50 may include a process 56 in communication with a memory 58. Wireless communication may be provided via the internet 60 (e.g., the cloud). Conventional communication devices, such as a router 62 and a hub 64 may be operably coupled intermediate the controller 26 and the internet 60 to facilitate communication therebetween.

In an illustrative embodiment, the process modules 30 may include a voice control module. For example, voice or verbal speech input from a user at a microphone of the user interface 32, 48 would be converted to an action by the controller 26. Such input from a user may control brewing (e.g., size, type and/or strength of a beverage), inventory management, and/or trigger automated reordering of product. Illustratively, the controller 26 may communicate with the central host 50 which then will provide reordering information.

Given wireless communication with the controller 24, remote operation of the beverage dispenser 12 (e.g., brewing) may be provided via the remote user interface 48. Additionally, inventory control may be provided via the remote user interface 48 and/or reordering may be provided directly via the remote user interface 48 by communicating with the central host 50.

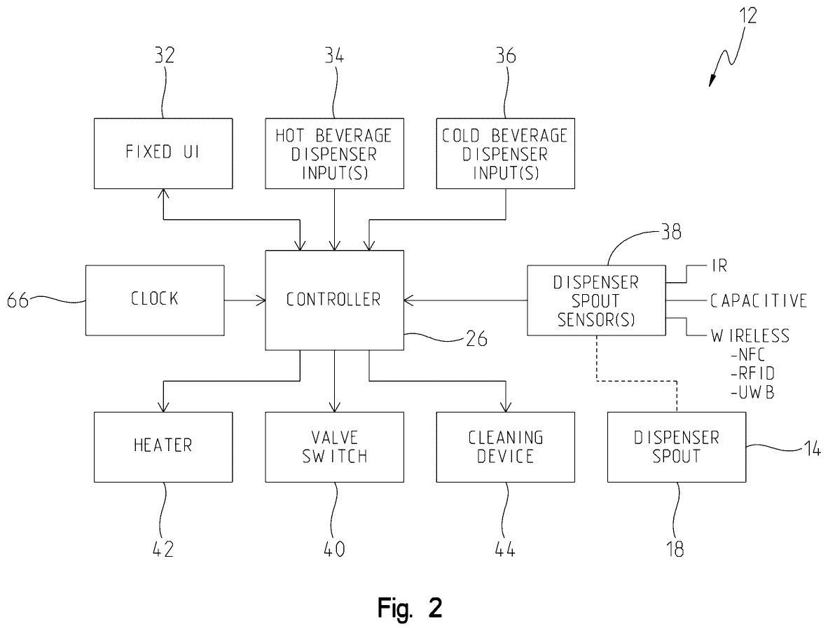

With further reference to FIG. 2, a clock 66 is illustratively in communication with the controller 26 and may facilitate data collection. For example, the controller 26 may store user dates and times of beverage dispensing and identify usage patterns. Such collected data may be stored in the memory 28 for later recall.

The illustrative process modules 30 may also include a data collection module, wherein the controller 26 may record the amount and kind of beverage that is typically used. The data collection module 30 may also record use history (e.g., date, time, duration) to predict typical beverage dispense times, beverage types and/or volumes. The data collection module 30 can also estimate how many days of product remains. For example, the controller 24 can compare coffee pods or k-cups used verses remaining inventory. Additionally, mixed drinks in inventory may be analyzed by the amount of pods or amount of types of alcohol dispensed. CO₂ may be also inventoried along with other beverage components such as soft drink syrup and/or beer. Again, the collected data from the data collection module 30 may be stored in the memory 28.

Illustratively, the system 10 may include a water filter where water filter use may also be recorded based upon water dispensed. A water quality sensor may also be provided in the system 10 which could measure how much water has gone through the filter. As such, the quality of the water may be analyzed as opposed to, or in addition to, the amount of filter life remaining.

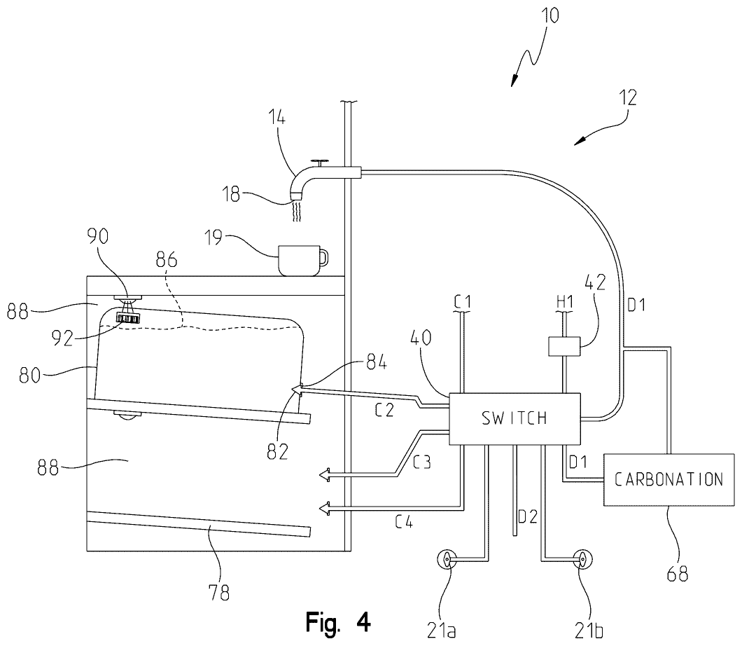

The remote user interface 48 may also be used for system configuration. For carbonated water (and/or mixed drinks) input to the user interface 48 provides the ability of the user to adjust the mixture and customize how strong a user wants the beverage. More particularly, the system 10 may include a carbonated dispenser (CO₂) 68 in communication with the controller 26, which may be remotely configured via the user interface 48 (FIGS. 1 and 4).

In an illustrative embodiment, Bluetooth may be utilized to connect the mobile application stored on the remote user interface 48 to initialize wireless communication (e.g., WiFi). The mobile application may connect to the internet (e.g., cloud) 60 under non-installation circumstances. It also allows for remote brewing, configuration, inventory, etc.

According to an illustrative embodiment, the dispenser spout sensors 38 operably coupled to the controller 26 may be utilized to control operation of the beverage dispenser 12. For example, an ultra-wideband (UWB) sensor to a user smart watch or smart phone may be utilized to localize who is in proximity of the dispenser spout 14. While smart watches are an illustrative embodiment, other devices may be substituted therefor, such as smart phones. Also biometric sensors to detect a user's biometric data may be used. These biometric sensors may detect unique physical characteristics, such as facial features, fingerprints, etc. This may be utilized by the controller 26 to determine who is requesting the beverage dispenser 12 to operate. Such input may also be used by the controller 24 to determine the type, size and/or dispensing time of the beverage.

A camera may also be utilized for near field communication/radio frequency identification (NFC/RFID) to determine the type of container or vessel 19 (e.g., cup/mug/container). Alternatively, RFID or codes could be utilized on the vessel 19 themselves. The camera may also watch the container 19 for correct location/orientation, as well as determining what kind of container 19 is being used so that the user may customize the beverage being dispensed to the container 19 being used.

As further detailed herein, the controller 26 may operate the valve assembly 40 and dispense beverages in response to input from the dispenser spout sensors 38. The dispenser spout sensors 38 may detect the presence and/or identification of the user and/or the vessel 19. In response thereto, the controller 26 will dispense a beverage illustratively of the desired type and/or volume. In certain illustrative embodiments, the sensors 38 may provide for user gesture control of the beverage dispenser 12. For example, the controller 24 may provide different functions based upon a variety of user inputs, such as an approaching user, a user moving the vessel 19 toward the outlet 18, a user moving the vessel 19 away from the outlet 18, a user moving to the right of the spout 14, a user moving to the left of the spout 14, etc.

With further reference to FIGS. 3 and 4, the beverage dispenser 12 may include a hot beverage device (e.g., a heater) 72 and a cold beverage device (e.g., a refrigerator) 74 fluidly coupled to the dispenser spout 14 and/or the delivery spout 23. The hot beverage device 72 illustratively includes the heater 42 positioned below the sink deck 16 and in fluid communication with a beverage holder or container 76. The beverage holder 76 may be configured to receive, for example, coffee grounds or tea leaves. In one illustrative embodiment, it may receive a traditional beverage pod (e.g., k-cup). The cleaning device 44 may be in communication with the beverage holder 76. In one illustrative embodiment, the cleaning device 44 may include compressed air. Additionally, a system may be provided for automatic disposal of used beverage remains or by-products (e.g., coffee grounds and/or tea leaves) following dispensing. This system may include a funnel that collects the byproducts and disposes them into a receptacle under the sink deck 16.

The cold beverage device 74 illustratively includes a storage rack 78 receiving a plurality of individual storage containers 80 that may be interchangeably positioned within the refrigerator 45. Each container 80 illustratively receives a drink or beverage liquid 86, such as soda syrup, and includes a valve 82 that may engage a receiving fluid coupler 84. Both the hot beverage and cold beverage devices 72 and 74 are in fluid communication with the valve assembly 40 as shown in FIG. 4.

Standard containers 80 may slide into a compartment 88 of the storage rack 78 and press into fluid communication with a quick release valve 82. The valve assembly 40 is configured to pull the correct beverage out of the dispenser 12 as instructed by the controller 24. A reader 90 may be provided in communication with the controller 26 to notify the consumer without looking at what compartments 88 are filled and with what beverage 86. For example, an indicator 92, such as a bar code, or QR code, may notify the user of what drink 86 is in each compartment 88. Generic containers may also be provided and programmed by the user through the user interface. Carbonation may be drawn later via the valve through the carbonation tank 68, for example. The system may carbonate the beverages and carbonation may be customized through the user interface 32, 48.

The hot beverage device 72 may include the beverage holder or container 76 below the deck 16 where coffee and tea may be brewed via the user interface 32, 48 without a vessel 19 (e.g., a coffee mug) necessarily being positioned proximate the spout 14. The illustrative holder 76 is directly coupled to a drain so that it may be flushed with water afterwards or disposed of if the consumer decides that the coffee is no longer wanted. A heater may be provided to maintain the brewed beverage for a certain time after being brewed. Illustratively, while conventional off-the-shelf beverage pods may be used, individual coffee grounds or tea leaves may be utilized in the container. Alternatively, a French press style unit may also be utilized.

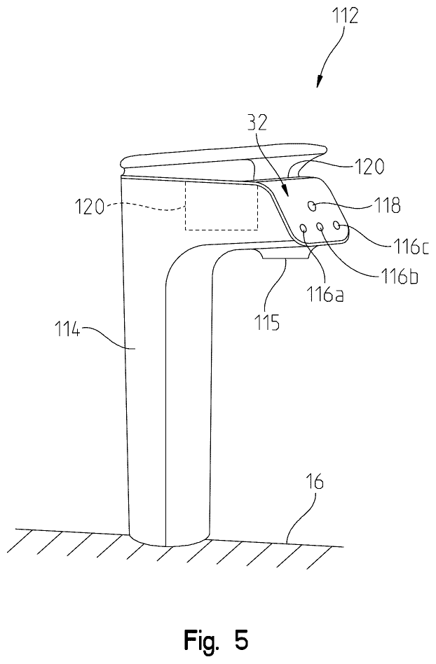

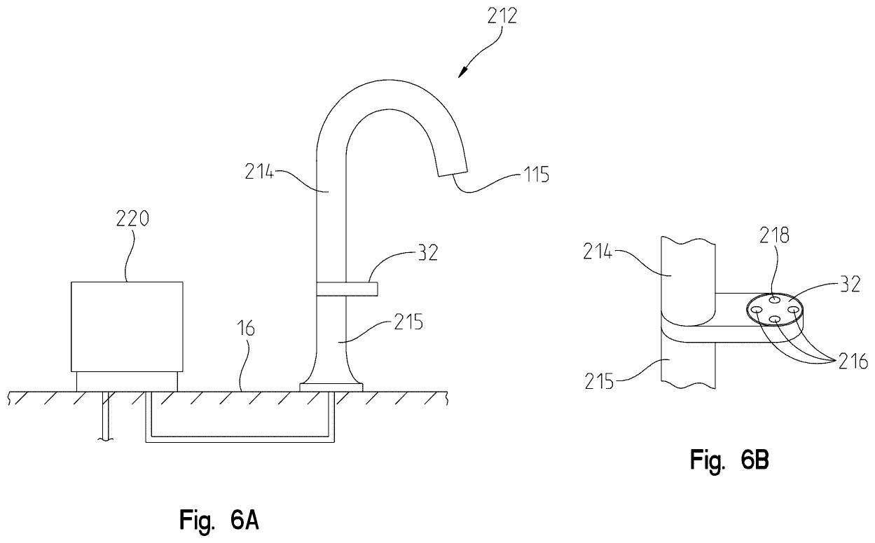

With reference now to FIGS. 5, 6A and 6B, a further illustrative beverage dispenser 112 is shown as including the user interface 32 supported by the spout 114 including a dispensing outlet 115. The user interface 32 may include a plurality of input buttons 116a, 116b, 116c and 118. A beverage pod compartment 120 is supported by an upper portion of the spout 114. A cover 122 is pivotably supported by the spout 114. The cover 122 may be raised and lowered to provide access to the compartment 120 for receipt and removal of a beverage pod (e.g., a K-cup).

With further reference to FIG. 5, the input buttons 116a, 116b, 116c and 118 may be backlit push buttons associated with different functions. For example, input button 116 a may be a low volume activation button (e.g., 6 ounces), input button 116 b may be a medium volume activation button (e.g., 8 ounces), and input button 116 c may be a high volume activation button (e.g., 10 ounces). In an initial state or mode, all three buttons 116 a, 116b, 116c are off. By a user pressing one of the buttons 116a, 116b, 116c, all are illuminated and the beverage dispenser 112 enters a selection mode. By the user pressing one of the buttons 116a, 116b, 116c, the beverage dispenser enters a dispensing mode and begins dispensing coffee (e.g., hot water passes through the beverage pod in the compartment 120) through the outlet 115 at the selected volume. By pressing the selected button 116a, 116b, 116c again during the dispensing mode, the beverage dispenser 112 will exit the dispensing mode and coffee dispensing ends, returning to the initial mode.

Input button 118 may be a hot water activation button. By pressing the button 118, it is unlocked and illuminated. Pressing the button 118 again causes the beverage dispenser 112 to dispense hot water from the outlet 115. By pressing the button 118 again, the beverage dispenser 112 will stop dispending hot water, returning to the initial mode.

In certain illustrative embodiments, the user interface 32 may also include a button (not shown) to activate a flushing function. During the flushing function, air from an air compressor may push remaining liquid from the beverage pod within the compartment 120.

With reference to FIGS. 6A and 6B, a further illustrative beverage dispenser 212 is shown as including the spout 214 supporting the user interface 32 outwardly from a spout base or hub 215. The user interface 32 may include a plurality of input buttons 216 and 218. A beverage pod compartment 220 is supported on the sink deck 16 in spaced relation to the spout 214. The beverage dispenser 212 may operate in a manner similar to the beverage dispenser 112 detailed above.

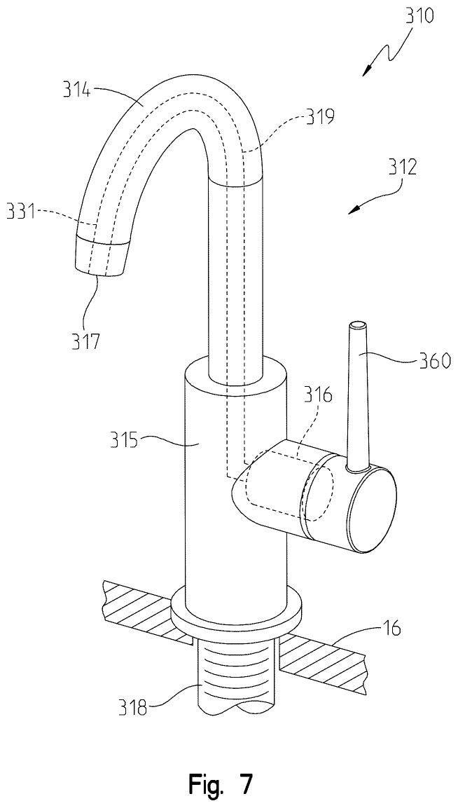

With reference to FIGS. 7-23, a further illustrative beverage dispenser system 310 is shown as including a beverage dispenser or faucet 312. The illustrative beverage dispenser 312 includes a delivery spout 314 supported by a main faucet body, or hub 315. A mixing valve 316 is illustratively received within the faucet hub 315 and is fluidly coupled to an outlet 317 of the delivery spout 314. An externally threaded mounting shank 318 illustratively cooperates with a mounting nut (not shown) to secure the faucet hub 315 to the sink deck 16. Illustratively, an outlet liner or tube 319 extends within the delivery spout 314 to provide fluid communication between the mixing valve 316 and the outlet 317 (FIG. 7).

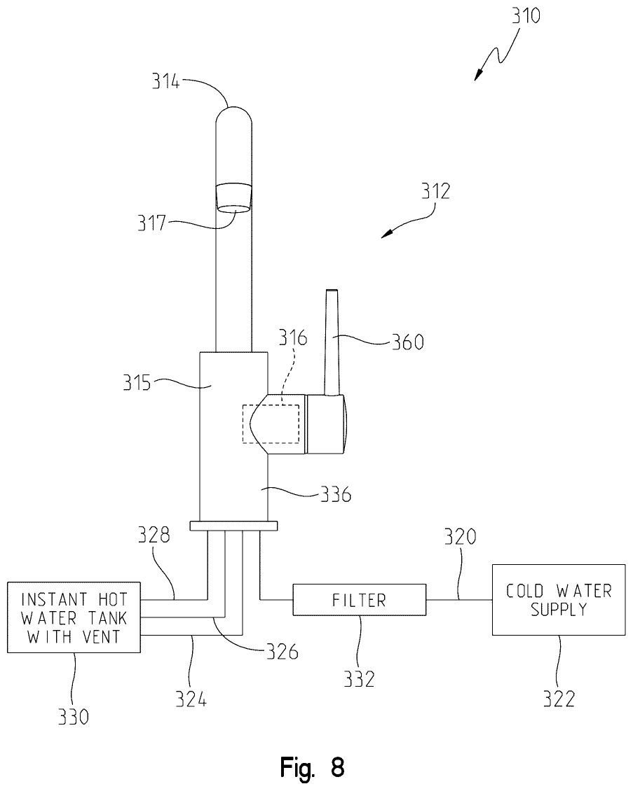

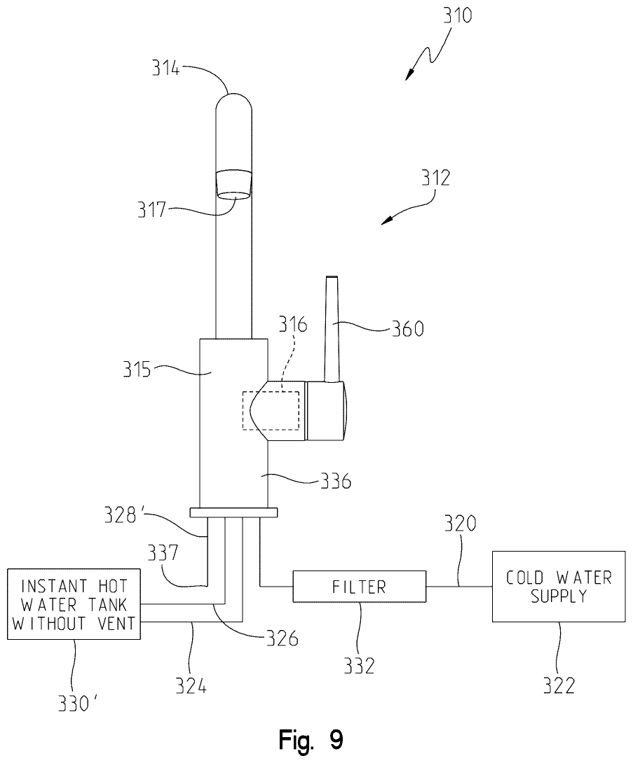

With reference to FIGS. 8-10, a fluid line or tube 320 fluidly couples or connects a cold water supply 322 to the faucet hub 315, while fluid lines or tubes 324, 326, 328 fluidly couple or connect a hot water supply or device (e.g. instant hot water tank) 330 to the faucet hub 315. As shown in FIGS. 8 and 10, the illustrative hot water supply 330 comprises an instant hot water tank with a vent. As shown in FIG. 9, the illustrative hot water supply 330′ comprises an instant hot water tank without a vent. As further detailed herein, the faucet hub 315 acts as a manifold 336 for delivering water to and from the valve 316 to the other components of the system 310 (cold water supply 322, hot water tank 330, and spout 314).

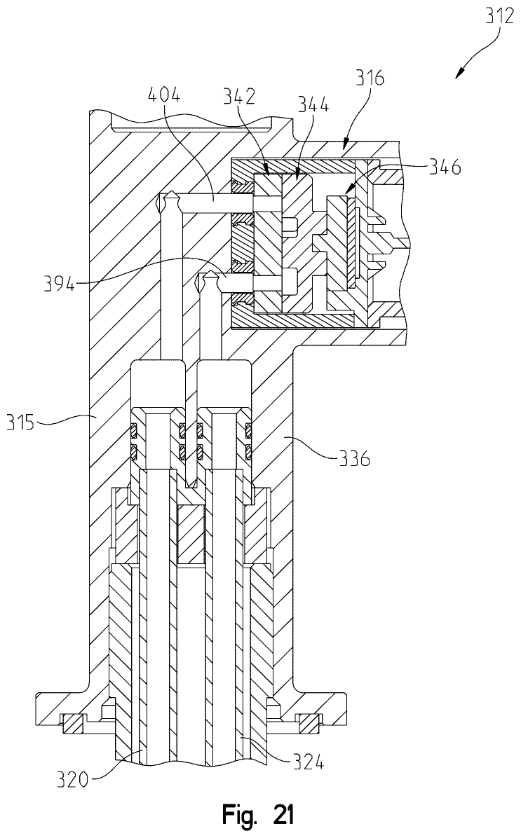

With reference to FIGS. 21-23, the hub 315 may also act as the connection between the hot water tank vent, if the hot water tank 330 has one (FIGS. 8 and 10), and a vent to atmosphere defined by an internal passageway 331 extending from the hub 315 through the spout 314 via a pathway through the valve 316 (FIGS. 7, 22 and 23). The passageway 331 extends around the outlet tube 319 to the outlet 317, such that fluid passing through the tube 319 is sealed from the fluid passing though the passageway 331. In such a configuration, the valve 316 essentially acts as a secondary vent. If the hot water tank 330 does not include an integral vent line, the faucet 312 provides for a vent through the valve 316 to the spout 314, improving performance of the previously unvented tank. The system 310 may also include a supply water filter 332 between the cold water supply 322 and the faucet hub 315 (FIGS. 8 and 9), and/or a supply water filter 334 between the faucet hub 315 and hot water tank 330 (FIG. 10).

With further reference to FIGS. 8-10, the fluid line 320 is a cold water supply line fluidly coupling the cold water supply 322 to the mixing valve 316, the fluid line 324 is a cold water to hot water tank line fluidly coupling the mixing valve 316 to the hot water supply 330, 330′, and the fluid line 326 is a hot water to faucet line fluidly coupling the hot water supply 330, 330′ to the mixing valve 316. With reference to FIGS. 8 and 10, the fluid line 328 is a hot water tank vent to faucet line fluidly coupling the vent of the hot water supply 330 to the mixing valve 316. Illustratively, the mixing valve 316 provides selective fluid communication between the vent of the hot water supply 330 to the passageway 331 of the spout 314. As shown in FIG. 9, the fluid line 328′ is illustratively a plugged line (no hot water tank vent connection line) fluidly coupled to the mixing valve 316 and having a sealed or plugged end 337.

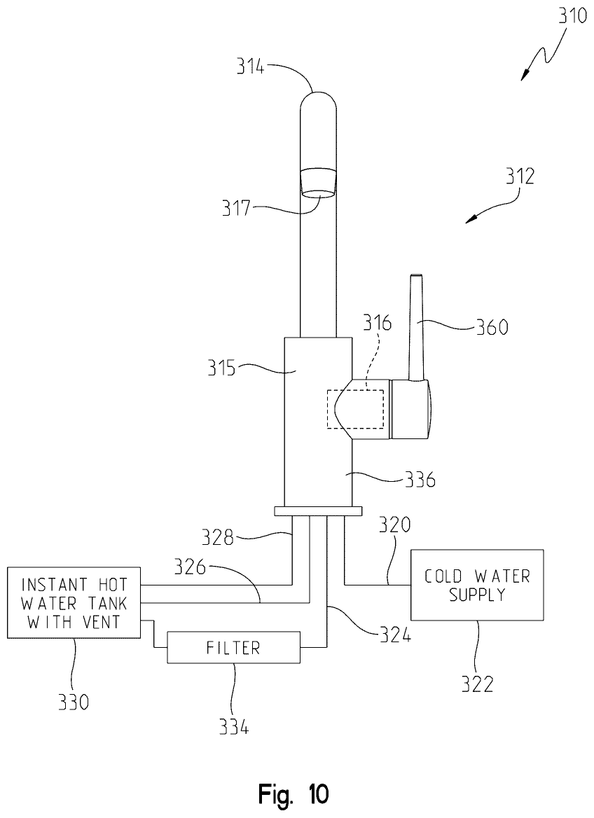

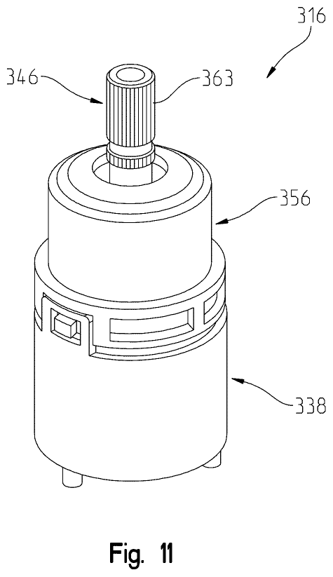

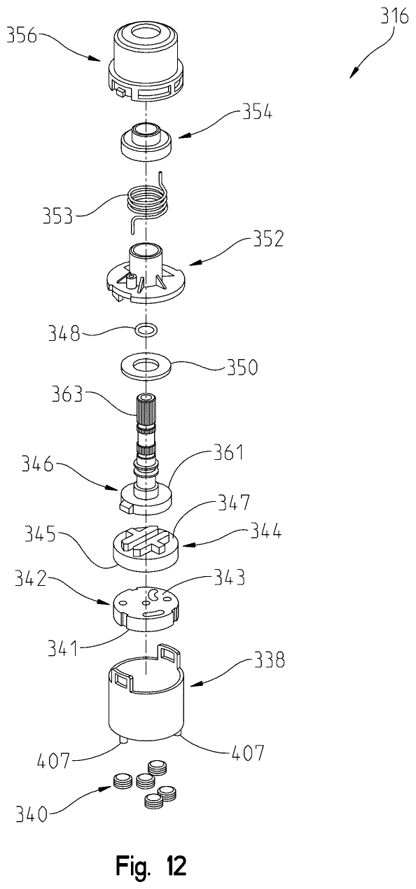

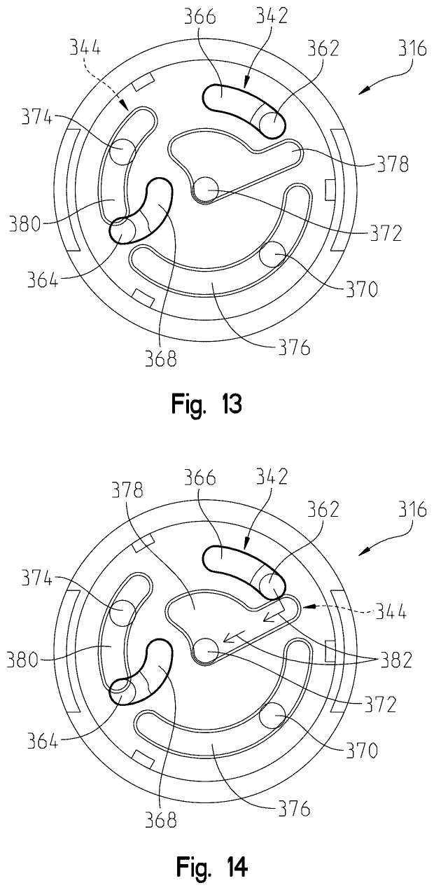

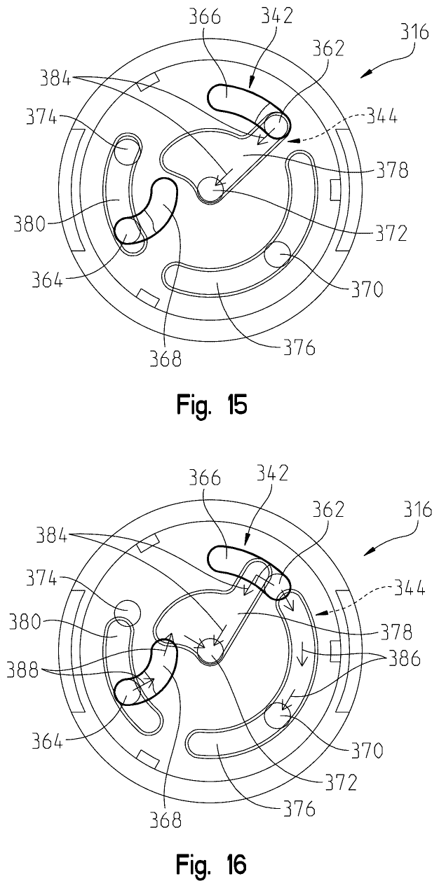

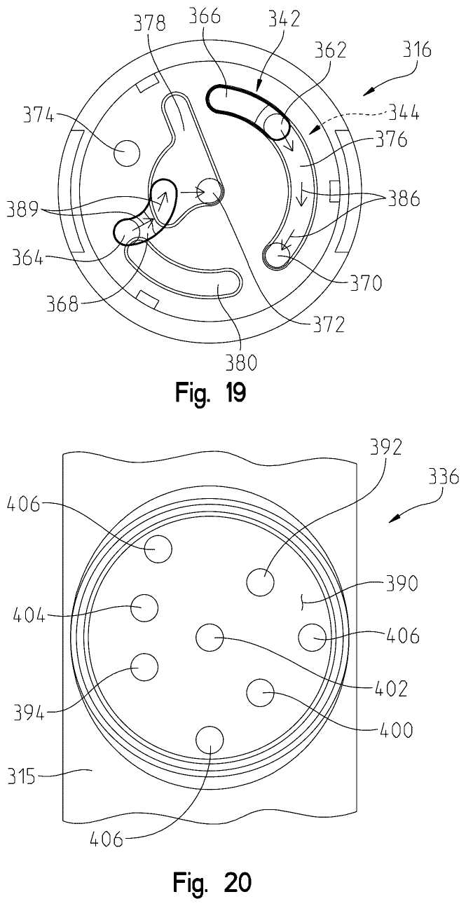

With reference to FIGS. 11 and 12, the mixing valve 316 includes a lower housing 338, port seals 340, a first valve member (e.g., a lower valve plate) 342, a second valve member (e.g., an upper valve plate) 344, a valve stem 346, an o-ring 348, a wear washer 350, a valve cap 352, a return spring 353, a spring disc 354, and an upper housing 356. The valve 316 operates through relative rotation of the valve plates 342, 344 (90 degrees as shown, but could vary depending on preference), moving from a closed position (FIG. 13), to a full cold position (FIG. 15), through a range of mixed water (from cooler to warmer) (FIGS. 16-18), and finally to a full hot position (FIG. 19).

Relative rotation of the valve plates 342, 344 is achieved through actuation of the valve stem 346, typically with an attached handle 360. The valve stem 346 includes a carrier 361 and a post 363. The carrier 361 of the valve stem 346 is fixedly coupled to the upper valve plate 344, while the lower valve plate 342 is fixed (no rotation) in the lower housing 338. The post 363 of the valve stem 346 is operably coupled to the handle 360 to facilitate rotation about its longitudinal axis of the post 363. The lower housing 338 is fixedly coupled to the faucet hub 315. The port seals 340 contained in the lower housing 338 provide a seal between the lower valve plate 342 and the faucet hub 315.

The lower valve plate 342 includes a lower surface 341 and an opposing upper surface 343, while the upper valve plate 344 includes a lower surface 345 and an opposing upper surface 347. The upper surface 343 of the lower valve plate 342 and the lower surface 345 of the upper valve plate 344 seal against each other, as in typical ceramic disc valves. The valve 316 is illustratively captured in the faucet hub 315 through conventional means of clamping, illustratively shown as a nut, but could be some other method (bayonet, spring clip, etc.).

The valve plates 342, 344 of the valve cartridge 316 allow temperature control through the operation of a single handle 360 applied to the instant hot water tank 330. The valve 316 controls the supply of water to the hot water tank 330 and back to the outlet 317 of the spout 314, but also incorporates a mixing function at certain angular orientations of the upper valve plate 344. Also, the inclusion of a vent path through the valve cartridge 316 to atmosphere when the faucet 312 is in the closed or off position, or any position before hot water is flowing from the hot water tank 330, provides a larger expansion chamber for the hot water tank 330, assuming it already includes a vent line, or adds a vent path for an unvented tank, and reduces noise.

With reference to FIGS. 12 and 13, the illustrative lower valve plate 342 includes a cold water inlet port 362 and a hot water inlet port 364. The cold water inlet port 362 is formed within a channel 366, while the hot water inlet port 364 is formed within a channel 368. Both channels 366 and 368 are illustratively arcuate recesses extending partially within the upper surface 343 of the lower valve plate 342. The illustrative lower valve plate 342 further includes a supply to tank inlet port (or cold water outlet port) 370, an outlet to spout port (or combined water outlet port) 372, and a vent port 374. Ports 362, 364, 370, 372 and 374 all extend through the lower valve plate 342 from the lower surface 341 to the upper surface 343. Illustratively, the outlet port 372 is formed proximate a center of the lower valve plate 342, and the ports 362, 364, 370 and 374 are positioned radially outwardly from the outlet port 372.

The illustrative upper valve plate 344 includes channels 376, 378 and 380 cooperating with the recesses 362, 364, 370, 372 and 374 of the lower valve plate 342. More particularly, the channels 376, 378 and 380 of the upper valve plate 344 are configured to move relative to the recesses 362, 364, 370, 372 and 374 of the lower valve plate 342. The channels 376 and 380 are illustratively arcuate recesses extending partially within the lower surface 345 of the upper valve plate 344. Similarly, the channel 378 is a recess extending partially within the lower surface 345 of the upper valve plate 344 and having portions extending radially outwardly from proximate a center of the upper valve plate 344.

In operation, the mixing valve 316 is configured to accept water from the cold-water supply 322, send that supply water directly to the spout 314 for dispensing, and/or send that water to the hot water tank 330, which in turn delivers hot water to the spout 314 for dispensing from the outlet 317. There are essentially three modes of dispensing depending on the position (angular orientation) of the handle 360 and the valve stem 346 as described above (cold, mix, and hot).

With reference to FIG. 20, the manifold 336 defined by the faucet hub 315 is shown as including an interface 390 configured to cooperate with the valve cartridge 316. The interface 390 of the manifold 336 illustratively includes a plurality of ports 392, 394, 400, 402 and 404 in fluid communication with the ports 362, 364, 370, 372 and 374 of the lower valve plate 342 of the valve cartridge 316, respectively. More particularly, the port 392 is a cold supply inlet in fluid communication with the cold water supply inlet port 362, the port 394 is a hot water from tank inlet in fluid communication with the hot water inlet port 364, the port 400 is a supply to tank inlet in fluid communication with the supply to tank inlet port 370, the port 402 is an outlet to the spout in fluid communication with the outlet to spout port 372, and the port 404 is a vent connection in fluid communication with the vent port 374. Valve orientation recesses 406 may receive protrusions 407 of the valve 316 to facilitate proper angular orientation between the valve 316 and the faucet hub 315.

FIGS. 13-19 illustrative different operating positions of the mixing valve 316 by rotation of the upper valve plate 344 relative to the lower valve plate 342. FIG. 13 illustrates the mixing valve 316 in an off or closed position where the ports 362, 370 and 372 of the lower valve plate 342 are not in fluid communication with each other (e.g., sealed from each other). As such, no water flows through the valve 316 to the outlet 317 of the spout 314. However, the hot water inlet port 364 is in partial fluid communication with the vent port 374 via the channel 380, thereby connecting the hot water tank 330 to the vent 331.

FIG. 14 illustrates the mixing valve 316 in a cold opening position where the upper valve plate 344 has been rotated counter-clockwise from the position of FIG. 13. In this position, the cold water supply inlet port 362 is in partial fluid communication with the spout outlet port 372 via the connecting channel 378. As such, cold water (as represented by arrows 382) flows at a relatively low flow rate from the cold water supply 322 to the spout outlet 317. Simultaneously, the hot water inlet port 364 remains in fluid communication with the vent port 374 via the connecting channel 380. As such, the hot water tank 330 is connected to the vent 331.

FIG. 15 illustrates the mixing valve 316 in a full cold position where the upper valve plate 344 has been rotated counter-clockwise from the position of FIG. 14. In this position, the cold water supply port 362 is in full fluid communication with the spout outlet port 372 via the connecting channel 378. As such, cold water (as represented by arrows 384) flows at a relatively high flow rate from the cold water supply 322 to the spout outlet 317. Simultaneously, the hot water inlet port 364 remains in fluid communication with the vent port 374 via the connecting channel 380. As such, the hot water tank 330 remains connected to the vent 331.

FIG. 16 illustrates the mixing valve 316 in a cold mix position where the upper valve plate 344 has been rotated counter-clockwise from the position in FIG. 15. In this position, the cold water supply port 362 remains in fluid communication with the spout outlet port 372, and the cold water supply port 362 is in partial fluid communication with the tank inlet port 370. Also, the hot water inlet port 364 is in fluid communication with the spout outlet port 372. As such, cold water flows from the cold water supply 322 to the spout outlet 317 (as represented by arrows 384), and simultaneously flows from the cold water supply 322 to the hot water tank 330 (as represented by arrows 386). Hot water also flows at a relatively low flow rate from the hot water supply 330 to the spout outlet 317 (as represented by arrows 388). The hot water inlet port 364 remains in partial fluid communication with the port 374 via the connecting channel 380. As such, the hot water tank 330 remains connected to the vent 331.

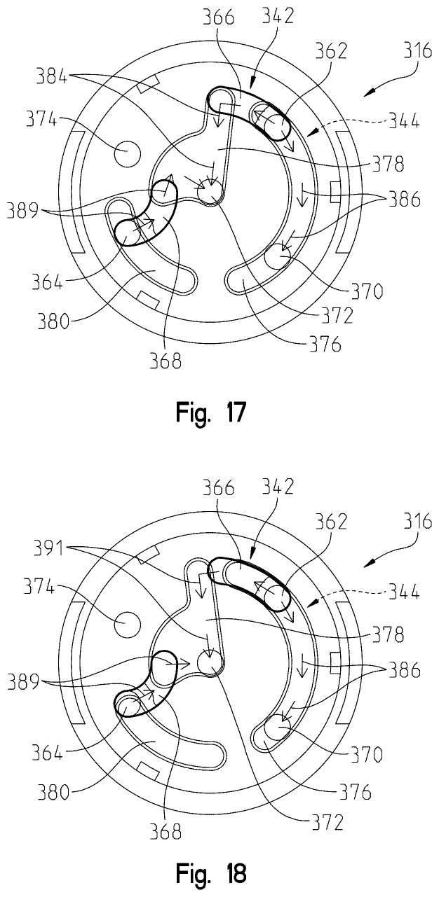

FIG. 17 illustrates the mixing valve 316 in a warm mix position where the upper valve plate 344 has been rotated counter-clockwise from the position in FIG. 16. In this position, the cold water supply port 362 remains in fluid communication with both the spout outlet port 372 and the tank inlet port 370. The hot water inlet port 364 is in increased fluid communication with the spout outlet port 372. As such, cold water flows from the cold water supply 322 to the spout outlet 317 (as represented by arrows 384), and simultaneously flows from the cold water supply 322 to the hot water tank 330 (as represented by arrows 386). Hot water also flows at an increased flow rate from the hot water supply 330 to the spout outlet 317 (as represented by arrows 389). In this position, the hot water inlet port 364 is no longer in fluid communication with the vent port 374. As such, the hot water tank 330 is not connected to the vent 331.

FIG. 18 illustrates the mixing valve 316 in a hotter mix position where the upper valve plate 344 has been rotated counter-clockwise from the position in FIG. 17. In this position, the cold water supply port 362 is in reduced fluid communication with the spout outlet port 372, and the cold water supply port 362 remains in fluid communication with the tank inlet port 370. The hot water inlet port 364 remains in fluid communication with the spout outlet port 372. As such, cold water flows at a decreased flow rate from the cold water supply 322 to the spout outlet 317 (as represented by arrows 391), and simultaneously flows from the cold water supply 322 to the hot water tank 330 (as represented by arrows 386). Hot water also flows from the hot water supply 330 to the spout outlet 317 (as represented by arrows 389). In this position, the hot water inlet port 364 is not in fluid communication with the port 374. As such, the hot water tank 330 is not connected to the vent 331.

FIG. 19 illustrates the mixing valve 316 in a full hot position where the upper valve plate 344 has been rotated counter-clockwise from the position in FIG. 18. In this position, the cold water supply port 362 is no longer in fluid communication with the spout outlet port 372. The cold water supply port 362 remains in fluid communication with the tank inlet port 370, and the hot water inlet port 364 remains in fluid communication with the spout outlet port 372. As such, cold water flows from the cold water supply to the hot water tank 330 (as represented by arrows 386). Hot water also flows from the hot water supply 330 to the spout outlet 317 (as represented by arrows 389). In this position, the hot water inlet port 364 is not in fluid communication with the port 374. As such, the hot water tank 330 is not connected to the vent 331.

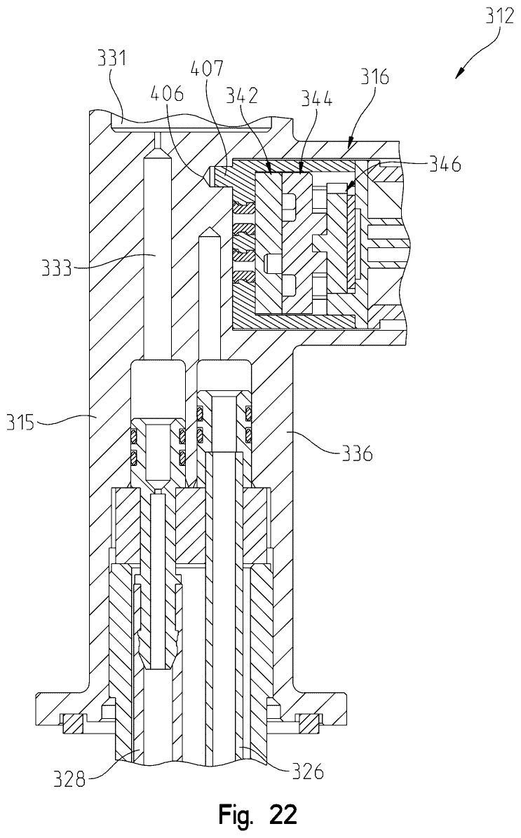

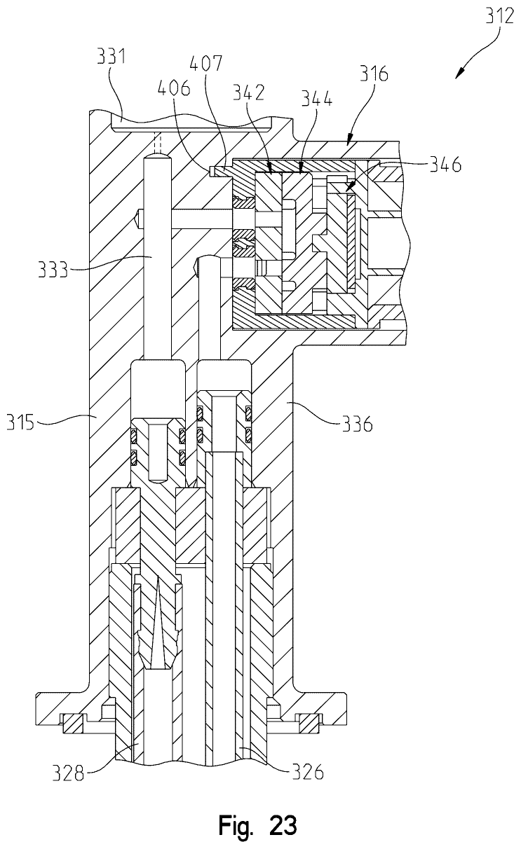

FIGS. 21-23 are cross-sectional views further illustrating cooperation between the mixing valve 316 and the manifold 336 at the interface 390. These cross-sectional views are taken at different parallel planes within the faucet hub 315. FIG. 21 illustratively corresponds to the positions of the mixing valve 316 shown in FIGS. 16-19. FIGS. 22 and 23 correspond to the positions of FIGS. 13-19 were the hot water tank 330 is connected to the vent 331. More particularly, FIG. 22 illustrates a conventional vent path defined by channel 333 within the faucet hub 315 and providing fluid communication between the hot water tank 330 and the vent 331. FIG. 23 illustrates a secondary path or channel for the hot water tank 330 where the mixing valve 316 provides fluid communication between the hot water tank 330 and the vent 331. This would be particularly useful for hot water tanks 330 with no pre-existing vent connection.

As detailed above, the passageway defining the vent 331 extends intermediate the outlet tube 319 and the delivery spout 314/faucet hub 315 from the mixing valve 316 to the outlet 317. In the illustrative embodiment, the vent 331 is only open (connected to the hot water tank 330) when the hot water tank 330 is not pressurized by the cold water supply 322 (FIGS. 13-16).

Additional details of an illustrative beverage dispensing system are shown in U.S. patent application Ser. No. 17/558,683, filed Dec. 22, 2021, and entitled “FLUID DISPENSING SYSTEMS AND METHODS”, the disclosure of which is expressly incorporated herein by reference.

Although the invention has been described in detail with reference to certain preferred embodiments, variations and modifications exist within the spirit and scope of the invention as described and defined in the following claims.

1. A beverage dispensing system comprising:
a beverage dispenser including a spout having an outlet;
a valve assembly in fluid communication with the spout;
at least one beverage container in fluid communication with the valve assembly;
a controller in communication with the valve assembly, the controller including a processor and a memory having machine readable instructions for execution by the processor;
a wireless transceiver in communication with the controller; and
a remote user interface in communication with the wireless transceiver.

2. The beverage dispensing system of claim 1, further comprising a plurality of process modules in communication with the controller, the process modules including at least one of a voice control module and a data collection module.

3. The beverage dispensing system of claim 1, wherein the remote user interface is in wireless communication with the controller via the internet.

4. The beverage dispensing system of claim 1, wherein the valve assembly comprises an electrically operable valve.

5. The beverage dispensing system of claim 1, further comprising a fixed user interface supported by the spout and in communication with the controller.

6. The beverage dispensing system of claim 1, further comprising a dispenser spout sensor operably coupled to the spout to detect an object in proximity to the outlet of the spout.

7. The beverage dispensing system of claim 6, wherein the dispenser spout sensor includes a capacitive sensor.

8. The beverage dispensing system of claim 1, further comprising a hot beverage device and a cold beverage device in communication with the controller, and fluidly coupled to the valve assembly.

9. The beverage dispensing system of claim 1, further comprising a cleaning device in communication with the controller, the cleaning device configured to clean portions of the beverage dispenser at predetermined times.

10-15. (canceled)

16. A beverage faucet comprising:
an outlet;
a valve cartridge that allows for water mixing and temperature control through the operation of a single handle and fluidly coupled to an instant hot water device; and
wherein the valve cartridge permits delivery of water from a cold water supply to the instant hot water device, delivery of water from the instant hot water device to the outlet of the beverage faucet, delivery of water from the cold water supply to the outlet of the beverage faucet, and delivery of a mixture of water from the instant hot water device and the cold water supply to the outlet of the beverage faucet.

17. The beverage faucet of claim 16, wherein the valve cartridge provides a vent passageway for the instant hot water device through the beverage faucet.

18. The beverage faucet of claim 16, further comprising a spout supported by a sink deck and including the outlet.

19. The beverage faucet of claim 16, wherein the valve cartridge includes a movable valve member having a cold water inlet port in fluid communication with the cold water supply, a hot water inlet port in fluid communication with an outlet of the instant hot water device, and a cold water outlet port in fluid communication with an inlet of the instant hot water device.

20. A beverage faucet comprising:
a spout including an outlet;
a hot water device;
a mixing valve including a moveable valve member having a cold water inlet port in fluid communication with a cold water source, a hot water inlet port in fluid communication with an outlet of the hot water device, a cold water outlet port in fluid communication with an inlet of the hot water device, and a combined water outlet port in fluid communication with the outlet of the spout; and
wherein movement of the moveable valve member includes a plurality of operating positions, the operating positions including a closed position, a full cold position, a mix position, and a full hot position.

21. The beverage faucet of claim 20, wherein:
the cold water inlet port is not in fluid communication with the combined water outlet port, and the hot water inlet port is not in fluid communication with the combined water outlet port in the closed position;
the cold water inlet port is in fluid communication with the combined water outlet port, and the hot water inlet port is not in fluid communication with the combined water outlet port in the full cold position;
the cold water inlet port is in fluid communication with the combined water outlet port, the hot water inlet port is in fluid communication with the combined water outlet port, and the cold water inlet port is in fluid communication with the cold water outlet port in the mix position; and
the cold water inlet port is not in fluid communication with the combined water outlet port, the hot water inlet port is in fluid communication with the combined water outlet port, and the cold water inlet port is in fluid communication with the cold water outlet port in the full hot position.

22. The beverage faucet of claim 20, further comprising:
a fixed valve member sealingly engaging the moveable valve member; and
a valve stem operably coupled to the moveable valve member.

23. The beverage faucet of claim 20, wherein the valve member further includes a vent port configured to provide selective fluid communication between the hot water device and atmosphere.

24. The beverage faucet of claim 23, wherein:
the vent port provides fluid communication between the hot water device and atmosphere in the closed position, the full cold position, and the mix position; and
the vent port does not provide fluid communication between the hot water device and atmosphere in the full hot position.

25-28. (canceled)
